(19) United States
(12) Patent Application Publication
(10) Pub. No.: US 2008/0285628 A1
(43) Pub. Date: Nov. 20, 2008

(54) COMMUNICATIONS SYSTEMS AND METHODS FOR REMOTELY CONTROLLED VEHICLES

(76) Inventors: Alexander C. Gizis, Philadelphia, PA (US); Francis Charles Szczerba, SR., West Chester, PA (US); Joseph Paul Kopanic, III, West Chester, PA (US)

Correspondence Address: WOODCOCK WASHBURN LLP, CIRA CENTRE, 12TH FLOOR, 2929 ARCH STREET, PHILADELPHIA, PA, 19104-2891, US

(21) Appl. No.: 11/750,090

(22) Filed: May 17, 2007

(51) Int. Cl. H04B 1/00

(52) U.S. Cl. 375/135; 446/454; 375/E01.033

(57) ABSTRACT

A remote controller and a remotely controlled vehicle employ, at least in part, frequency hopping spread spectrum communications to communicate information between them. The remote controller transmits information for controlling the remotely controlled vehicle on substantially all of the frequencies of a hop sequence established by the two devices, but only transmits information indicative of the established communications between the devices on a subset of the frequencies of the sequence, the subset of frequencies comprising less than substantially all of the frequencies of the sequence. Additionally, the remote controller continues to transmit the information for controlling the remotely controlled vehicle on substantially all of the frequencies of the sequence even if the remotely controlled vehicle loses communication with the remote controller. A mathematical function is applied to identifiers associated with each device to generate an identifier representative of the established communications link between them.

### FIELD OF THE INVENTION

The present invention relates to communications between a remote controller and a remotely controlled vehicle.

### BACKGROUND

Hobbyists build and race radio controlled vehicles which may be scale models of cars, trucks, boats, tanks, airplanes, helicopters, etc. Typically, a driver holds a remote controller (commonly referred to as a “transmitter”) that sends control commands or signals wirelessly to a radio receiver in the vehicle, which then passes the control signals to servo motors in the vehicle to control its speed, direction and other functions. Some systems provide two-way communications so that in addition to the remote controller sending commands to the vehicle, the vehicle transmits telemetry data (e.g., speed) back to the remote controller, which may then be displayed to the user.

Often, drivers compete by driving their vehicles in races. In such races, the radio systems are a key component to the success of a driver, as even fractions of a second make a large difference in the control of a small vehicle driving on a track at speeds of as much as 40 mph. Two factors in particular that affect the success of a radio control system in such applications are: (a) latency, defined as the average time between a driver issuing a command and the vehicle responding; and (b) reliability of the radio link, as it is not good for a driver to lose control of the vehicle.

Until recently, the radios used in these applications have been either AM or FM radios, and the receiver and transmitter are tuned to the same frequency. Often, the transmitter and receiver radios must be manually set to the same frequency, and there usually is no form of error correction. If the signal gets corrupted in the air, the receiver will send incorrect commands to the servos which may lead to “twitching” of the servos. Also, receivers may accept any commands that they receive on the frequency to which they are tuned. If a second driver sets his radio to the same frequency, the vehicles of those two drivers may receive a corrupted mix of commands from the two radios.

More recently, several companies have released radios that employ spread spectrum communications technologies. There are two common forms of spread spectrum communications—direct sequence spread spectrum (DSSS) and frequency hopping spread spectrum (FHSS). Spread spectrum radios typically operate in the 2.4 GHz Industrial, Scientific and Medical (ISM) band. These newer devices can offer several advantages over the older radio technologies, including error detection and correction, message identification, automatic frequency selection, and faster message rates.

Direct sequence spread spectrum radios stay on one channel and transmit each bit of data across multiple adjacent frequencies within the channel. In this manner, even if a transient noise source briefly interrupts, the radio's redundant sending of information is likely to get the message through when the source of interference goes away. Frequency hopping spread spectrum radios avoid interference by rapidly changing channels. In this way, if interference causes a message to be corrupted, the next message can be expected to get through since it will be on another channel.

Despite the improvements that these spread spectrum technologies provide, neither is entirely immune to interference. For example, direct sequence spread spectrum radios may lose their link if a source of interference which is too strong for any of the redundant messages to get through is present on the same channel and stays there. Frequency hopping radios may be able to maintain their links in such conditions because they continuously hop to different frequencies that may avoid the interference present on one channel. However, they may lose individual messages much more often than direct sequence radios will, as they do not have the redundancy to protect their signals when they do transmit on a frequency with a source of interference. This can result in reduced radio performance because a large number of packets may not get delivered.

Additionally, in order to be used successfully in two-way hobbyist racing applications, both types of radios must overcome the severity of the “near far” problem during race conditions. In a typical competitive race, as many as ten drivers will stand together shoulder-to-shoulder on a raised platform known as a drivers' stand. If many radios are operating on the same band at full speed and power in such a small area, it can become difficult for the remote controllers to receive messages from their respective vehicles, even if the radios are on different frequencies.

Many of these same issues are faced in a variety of other remotely controlled vehicle applications, including for example the remote control of robotic vehicles in battlefield environments or in explosives handling. It is understood that the present invention is applicable to all such remotely controlled vehicle applications and is not limited to the hobbyist racing application discussed above.

### SUMMARY

The present invention relates to improved systems and methods for communicating between a remote controller and a remotely controlled vehicle.

According to one system and method, a remote controller and a remotely controlled vehicle employ, at least in part, frequency hopping spread spectrum communications to communicate information between them. The remote controller transmits information for controlling the remotely controlled vehicle on substantially all of the frequencies of a hop sequence established by the two devices, but only transmits information indicative of the established communications between the devices on a subset of the frequencies of the sequence, the subset of frequencies comprising less than substantially all of the frequencies of the sequence. Additionally, the remote controller continues to transmit the information for controlling the remotely controlled vehicle on substantially all of the frequencies of the sequence even if the remotely controlled vehicle loses communication with the remote controller.

According to another system and method, the remote controller and the remotely controlled vehicle each have a respective identifier, and those identifiers each have a respective length in bits. A mathematical function is applied to the identifiers of the remote controller and remotely controlled vehicle to generate an identifier representative of an established communications link between the two devices. The generated identifier has a length that is less than the combined lengths of the identifiers of the remote controller and remotely controlled vehicle. The generated identifier is periodically (i.e., from time-to-time) transmitted to the remotely controlled vehicle to at least in part identify the established communications link. A property of the mathematical function is that given the generated identifier and one of the identifiers of the remote controller or remotely controlled vehicle, the other identifier can be determined by reverse application of the function. In one embodiment, the remote controller and remotely controlled vehicle identifiers each have a same length L, and the generated identifier has that same length L.

Other features of the invention are described hereinafter.

### BRIEF DESCRIPTION OF THE DRAWINGS

The foregoing summary, as well as the following detailed description, is better understood when read in conjunction with the appended drawings. For the purpose of illustration, there is shown in the drawings examples of embodiments of various aspects of the invention; however, the invention is not limited to the specific methods and instrumentalities disclosed. In the drawings:

FIG. 1(a) is an illustration of an example remote controller, and FIG. 1(b) is an illustration of an example transceiver module for a remotely controlled vehicle, in which the invention may be embodied;

FIG. 2 is a block diagram illustrating further details of the components of the example remote controller of FIG. 1(a);

FIG. 3 is a block diagram illustrating further details of the components of the example transceiver module of FIG. 1(b);

FIGS. 4(a) and 4(b) comprise a flow diagram illustrating steps performed by a remote controller and remotely controlled vehicle in accordance with one embodiment of the invention;

FIG. 5 illustrates one embodiment of a format of a packet of information transmitted from the remote controller to the remotely controlled vehicle; and

FIG. 6 illustrates one embodiment of a format of a packet of information transmitted from the remotely controlled vehicle to the remote controller.

### DETAILED DESCRIPTION

The subject matter of the present invention is described with specificity to meet statutory requirements. However, the description itself is not intended to limit the scope of this patent. Rather, the inventors have contemplated that the claimed subject matter may also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly described.

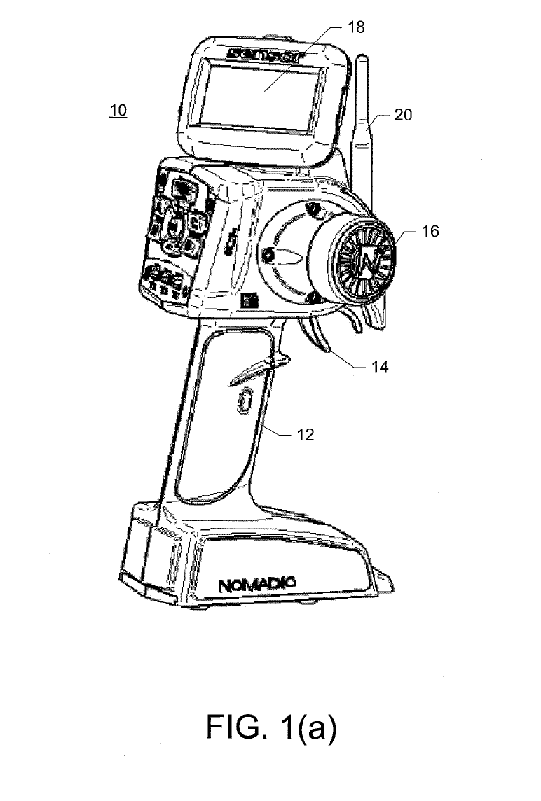

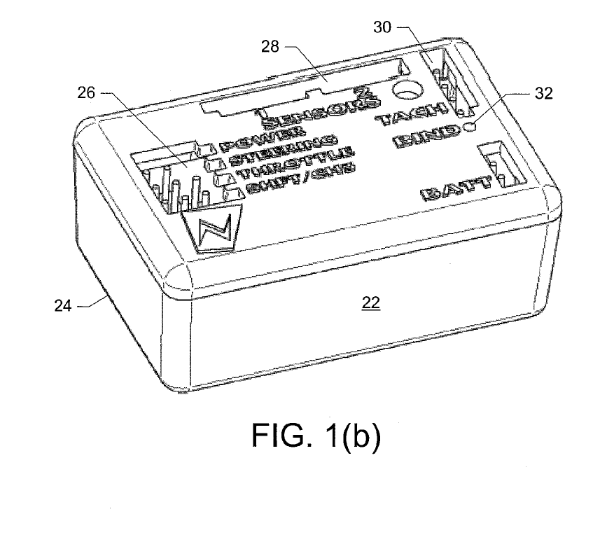

FIG. 1(a) is an illustration of one example of a remote controller 10 in which the present invention may be embodied. As shown, in this example, the remote controller 10 is a hand-held device. A user holds a handle 12 of the remote controller in one hand and operates a movable trigger 14 with a finger to provide vehicle throttle control. The user rotates a wheel 16 to provide steering control for the vehicle. Of course, the remote controller may employ other forms of control, such as joysticks, trackballs or other control devices, and is not limited in any way to the particular control mechanisms illustrated in FIG. 1(a). Moreover, while the remote controller 10 is shown as a single device, in other embodiments, the remote controller may comprise separate components. The remote controller 10 may include a display screen 18 to provide information to the user, such as vehicle telemetry data and other status information. The display 18 may also be used to display a graphical representation of link quality to give the user a visual representation of radio performance. The display 18 may also be used to enable the user to establish device settings or otherwise control the device. The remote controller 10 transmits information to the remotely controlled vehicle via an antenna 20.

FIG. 1(b) is an illustration of an example transceiver module 22 that may be mounted in a remotely controlled vehicle (not shown) in order to communicate with the remote controller 10 and to provide signals for controlling the operation of the vehicle. The remotely controlled vehicle may take any of a variety of forms, including cars, trucks, boats, tanks, airplanes, helicopters, robots or any other vehicle or mobile device. The transceiver module 22 comprises a housing, output pins 26 that can be connected to various mechanisms within a vehicle, such as motors, servos, steering mechanisms, transmissions, robotic arms or any other mechanisms, to provide signals for controlling them. The transceiver module also includes a variety of inputs 28, 30 to which vehicle sensors can be attached so that telemetry data from the vehicle can be transmitted back to the remote controller. An LED 32 may provide an indication when a communication connection between the remote controller and the transceiver has been successfully established, as described in greater detail below. In the present embodiment, the transceiver module includes an antenna (not shown) that may be disposed within the housing or that may extend external to the housing.

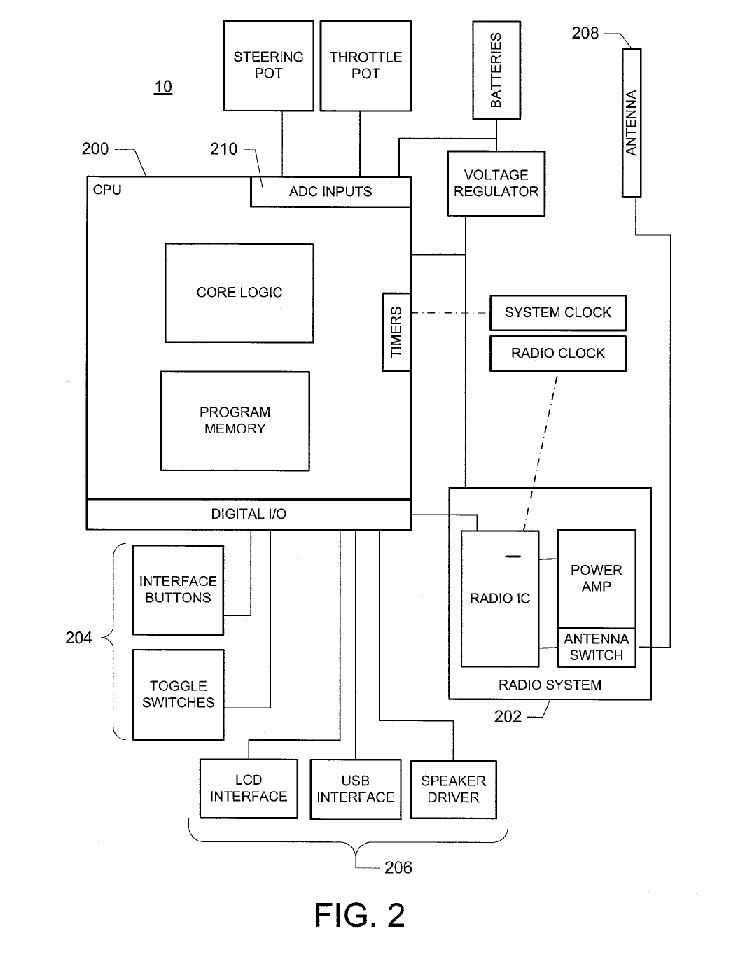

FIG. 2 is a block diagram illustrating further details of the components of the example remote controller of FIG. 1(a). As shown, in this embodiment, the remote controller comprises a microprocessor 200 which executes stored program code. The remote controller further comprises a variety of interfaces, such as a speaker driver, a Universal Serial Bus (USB) interface, and a liquid crystal display (LCD) interface that may be connected to the display 18 of FIG. 1(a). Various buttons and switches 204 may allow the user to navigate a menu system and to trigger actions such as shifting gears in vehicles with a transmission. A radio system 202 comprising a radio modem, a power amplifier and an antenna switch implement a 2-way (transmit and receive) radio. In the present embodiment, the radio modem comprises a 2.4 GHz Direct Sequence Spread Spectrum (DSSS) Gaussian Frequency Shift Keying (GFSK) baseband modem that connects to the microprocessor 200 via a serial peripheral interface (SPI). The power amplifier increases the power of the output radio signal to enhance effective range. In the present embodiment, the radio system is implemented using a Cypress Semiconductor CYWUSB6935 chip to provide the radio modem functionality and a SiGe SE2526A to provide the power amplifier and antenna switch functionality. An analog-to-digital converter (ADC) 210 may receive analog input signals from control mechanisms, such as the trigger 14 and wheel 16 of FIG. 1(a), to provide fine-grain, precise control of a vehicle. The remote controller may also include several analog outputs (not shown) that provide, for example, sounds or vibrations to allow the user greater feedback from either the configuration system or the telemetry coming back from the vehicle.

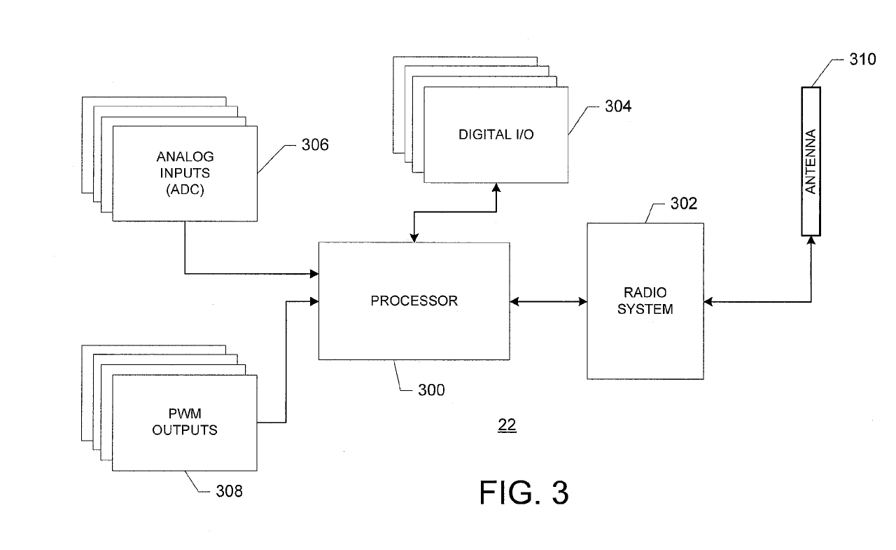

FIG. 3 is a block diagram illustrating further details of the components of the example transceiver module 22 of FIG. 1(b). As shown, the module comprises a microprocessor 300 which executes stored program code; a radio system 302 comprising a radio modem and power amplifier that complements the radio system 202 in the remote controller 10. The module also comprises a number of pulse-width modulation (PWM) outputs 308 that may be connected to a vehicle's motors, servos or other mechanisms. The PWM outputs 308 may provide direct control of a motor or may provide servo pulses to control servos. The module 22 may also have one or more analog inputs 306 to capture data such as, for example, battery levels or temperature. The module may also have one or more digital inputs or outputs 304, such as, for example, a serial port or general-purpose input/output pins. These can be used to interface to other digital devices such as tachometers, accelerometers, or GPS devices among others. When reference is made hereinafter to communications with the remotely controlled vehicle, it is understood that such communications are carried out by a receiver or transceiver module, such as module 22, which is mounted or otherwise included with the vehicle.

In the present embodiment, the radios employ both direct sequence spread spectrum and frequency hopping spread spectrum techniques. However, in other embodiments, frequency hopping spread spectrum communications alone may be employed. In the present embodiment, the radios communicate in the 2.4 GHz Industrial, Scientific, and Medical (ISM) band, although in other embodiments, other frequency ranges can be employed.

In accordance with one aspect of the invention, each of the remote controller and remotely controlled vehicle (i.e., the transceiver module in the remotely controlled vehicle) has an identifier. In the present embodiment, each device has a globally unique identifier (GUID) comprising 32-bits. It is understood, however, that in other embodiments the identifiers may not be globally unique and may comprise a different number of bits.

For purposes of description and illustration only, the remote controller (or its radio modem) may sometimes be referred to as the “transmitter,” and the remotely controlled vehicle (or its radio modem) may be referred to as the “receiver.” It is understood, however, that the system is capable of two-way communications and thus reference to one of the radio modems as the “transmitter” or “receiver” should not be construed as limiting that device to just transmitting or receiving. To the extent that a radio is capable of both transmitting and receiving, it may also be referred to herein as a “transceiver.” Also, again for purposes of description only, the identifier of the remote controller is sometimes referred to hereinafter as the “TX ID,” and the identifier of the remotely controlled device is referred to as the “RX ID.” However, the designations “TX” and “RX” are not meant to be limiting in any way and should not be construed as suggesting any limitation on a device's ability to transmit or receive.

Direct Sequence Spread Spectrum

As mentioned above, in the present embodiment, the radios in the remote controller and remotely controlled device employ, at least in part, direct-sequence spread spectrum (DSSS) communications. As also mentioned above, in the present embodiment, 2.4 GHz DSSS GFSK baseband modems are employed to perform the DSSS communications. These radios operate in the worldwide 2.4 GHz ISM frequency band, dividing the ISM band into 78 channels, each of which is 1 MHz wide.

DSSS generates a redundant bit pattern, known as a Pseudo-Noise (PN) code for each bit to be transmitted. The PN codes are selected to make a signal appear to be random noise. In the present embodiment, each bit is transmitted 32 times. The transceiver in the remotely controlled vehicle utilizes a copy of the same PN code as the transmitter and a matched filter to find signals on the same frequency which are transmitted using the same PN code. The filter will not respond to either random noise (except in very unlikely events) or signals transmitted using other PN codes. Use of direct sequence spread spectrum techniques may provide coding gain for improved range, redundant encoding for noise immunity, and support for multiple co-located devices.

In the present embodiment, the PN code used to spread the spectrum is chosen randomly at remote controller startup. In the present embodiment, to allow the radio in the remotely controlled vehicle to determine the PN code selected by the remote controller, connection establishment information sent to the remotely controlled vehicle is transmitted using a single PN code reserved by the remote controller and remotely controlled vehicle for this purpose.

Frequency Hopping

As mentioned above, the radios in the remote controller and remotely controlled device also implement a frequency hopping algorithm. In the present embodiment, the frequency hopping algorithm is implemented in software by shifting frequencies between every transmitted DSSS packet according to an agreed upon pseudo-random pattern. In this embodiment, the algorithm comprises a long-period frequency hopping algorithm that is controlled by three inputs: a hop clock value, the identifier of the remote controller (i.e., TX ID), and the identifier of the remotely controlled device (RX ID). In the present embodiment, all three of these values comprise 32-bits, but in other embodiments, they may comprise a different number of bits. The hop clock value is initialized on the remote controller to a random value. As described more fully below, it is then transmitted to the remotely controlled vehicle along with the other inputs to the hop algorithm. Using these inputs, the remote controller and the remotely controlled vehicle generate (and hop through) a sequence of frequencies in a synchronized manner. In the present embodiment, the hop sequence comprises seventy-nine different channels (i.e., frequencies), and the radios hop through the sequence at a rate of one-hundred (100) hops per second.

In one embodiment, although the hop algorithm uses 79 as the number of channels in the hop sequence (because it is prime), only 78 channels are actually used by the radio modems. Specifically, in this embodiment, the use of 78 channels is achieved by selecting a replacement channel from the set of used channels whenever channel 78 is selected initially.

Also in the present embodiment, as described in greater detail below, a subset of the channels of the hop sequence is designated for use in transmitting information identifying an established communication connection between the remote controller and the remotely controlled device.

Connection Establishment

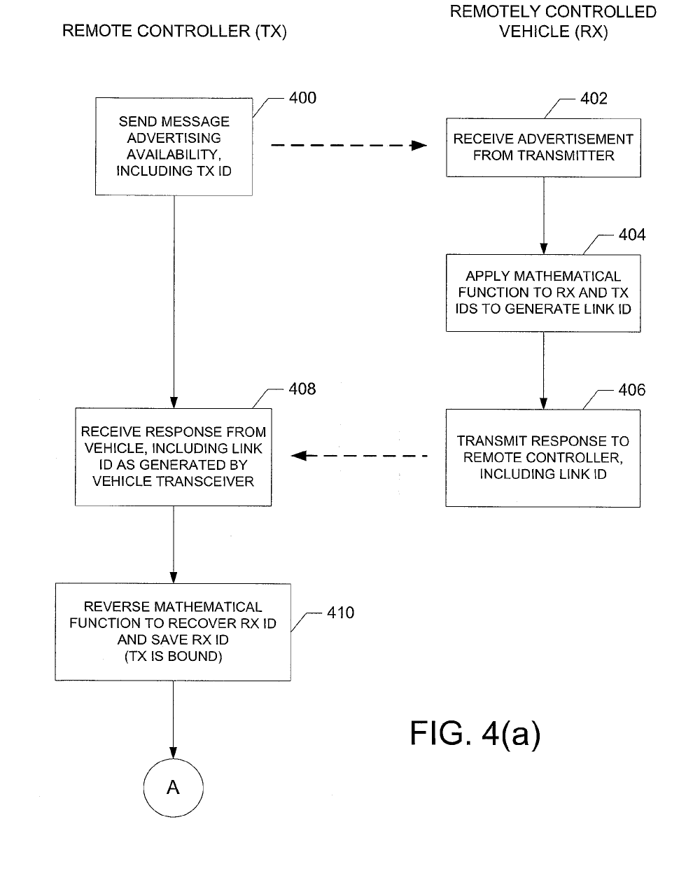

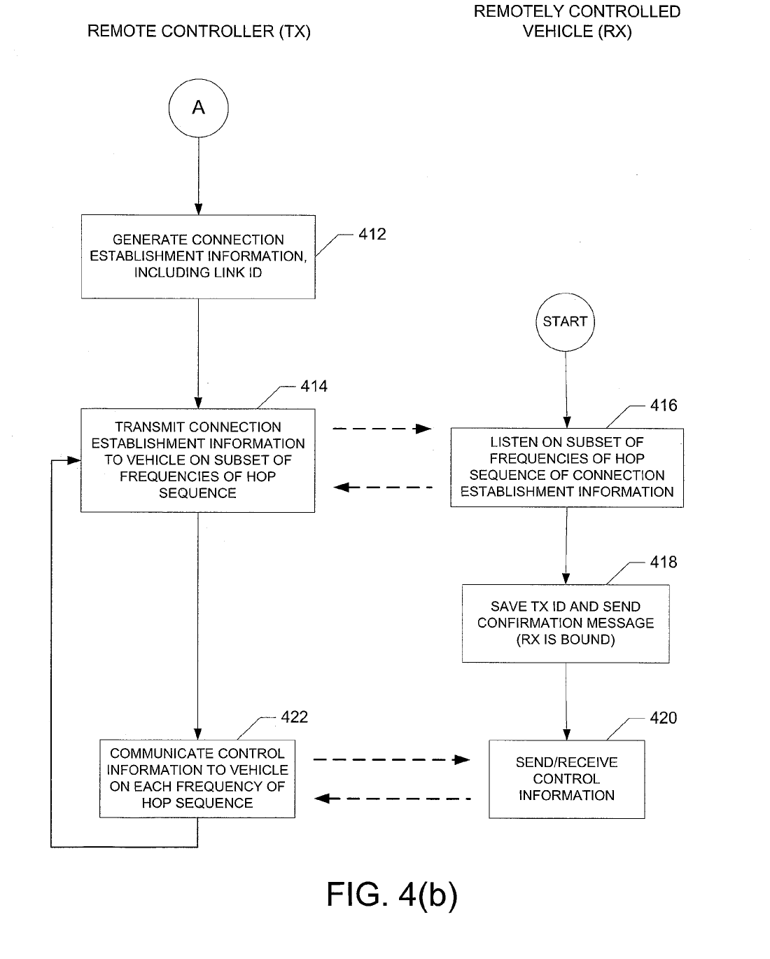

FIGS. 4(a) and (b) comprise a flow diagram illustrating the steps performed by a remote controller and remotely controlled vehicle to establish a communication link between them in accordance with an embodiment of the invention. The process of establishing a communication link between the remote controller and the remotely controlled device may also be referred to herein as a “bind” process, and when a link has been established the devices may be referred to as having been “bound” to each other. The steps illustrated in FIGS. 4(a) and 4(b) assume that the two devices are presently unbound.

As shown in FIG. 4, the connection establishment process begins at step 400 where the remote controller transmits an advertisement message indicating its availability for connection with a remote vehicle. In the present embodiment, information is transmitted between the remote controller and a remotely controlled vehicle in the form of packets of information, and the advertisement message (i.e., packet) comprises, among other information: (1) an 8-bit tag value that is formed as a function of the remote controller ID (i.e., TX ID); (2) a 32-bit preliminary link identifier that is generated by applying a mathematical function to the TX ID and the value 0 (that is, the TX ID and the value 0 are inputs to the mathematical function); and (3) a 16-bit CRC (cyclic redundancy check) value that is initialized with a seed value.

At step 402, the radio modem in a remotely controlled vehicle receives the advertisement message from the remote controller. Because the remotely controlled vehicle is not bound to any controller, it assumes that it has received the advertisement message from an unbound remote controller. In response to the message, the remotely controlled vehicle performs the reverse of the mathematical function used by the remote controller to generate the preliminary link ID, using a value of 0 as the input, and extracts therefrom the identifier of the remote controller (TX ID). From this recovered TX ID the remotely controlled vehicle generates a CRC seed and checks the packet integrity. All three values must be consistent to allow processing to continue. In step 404, the remotely controlled vehicle then generates a new link identifier by applying the mathematical function to the remote controller identifier (TX ID) and its own identifier (RX ID); that is, the two identifiers are provided as inputs to the mathematical function.

In the present embodiment, the mathematical function generates a link identifier having a length equal to the length of each device identifier. For example, in the present embodiment, where the remote controller and remotely controlled device identifiers each comprise 32-bits, the generated link identifier also comprises 32-bits. One property of the mathematical function used to generate the link identifier is that given one of the identifiers input to the function (e.g., TX ID or RX ID), it is possible to reverse the function to retrieve the other identifier. Another property of the mathematical function is that if neither of the input identifiers is known, no information is provided about either of those identifiers. In other embodiments, the generated link identifier may comprise more or less than the number of bits in one of the device identifiers, however, it is preferable that the generated link identifier comprises less than the number of bits of the two device identifiers together. By generating a link identifier that comprises less than the combined number of bits of both device identifiers, and from which each identifier can be retrieved given the other identifier, an established connection between the two devices can be represented in transmissions between them without having to transmit both of the device identifiers individually. Also, some level of security is provided in that if neither of the input identifiers is known, no information is provided about either of those identifiers from the link identifier itself.

Next, in step 406, the remotely controlled vehicle transmits a response to the remote controller's advertisement message back to the remote controller. This response message includes the same 8-bit link tag and 16-bit seed value contained in the advertisement message from the remote controller, together with the generated link ID computed by the remotely controlled vehicle.

At step 408, the remote controller receives the response message from the remotely controlled vehicle. At step 410, the remote controller compares the 8-bit link tag contained in the response message to the link tag sent in the advertisement message to confirm that the received message is a response to the advertisement message. The remote controller then applies the reverse mathematical function to the received link ID using its transmitter identifier (TX ID) as an input. This results in the receiver identifier (RX ID) being recovered from the link ID. The remote controller then stores the receiver identifier in its memory. The remote controller is now “bound.”

Referring now to FIG. 4(b), at step 412, the remote controller generates a new set of connection establishment information. In particular, in the present embodiment, the remote controller generates a new 8-bit link tag as a function of both the TX ID and the RX ID and a new link ID by applying the above-mentioned mathematical function to the TX ID and RX ID. In the present embodiment, the connection establishment information further comprises a current hop clock value and the PN code to be used by the remote controller and remotely controlled vehicle to effect direct sequence spread spectrum communications on the channels in the hop sequence. The remote controller also generates a new 16-bit CRC seed value.

Next, in step 414, the remote controller begins transmitting the connection establishment information. As described in greater detail below, in the present embodiment, the remote controller transmits the connection establishment information on only a subset of the channels (i.e., frequencies) in the hop sequence.

At step 416, the remotely controlled device has begun listening on the subset of channels for the connection establishment information. When the connection establishment information is received from the remote controller (step 418), the remote controller applies the reverse of the mathematical function to the generated link ID, using the RX ID as an input, to recover the remote controller's identifier (i.e., TX ID). The remotely controlled vehicle then saves the TX ID in its non-volatile memory. At this point, the remotely controlled vehicle is now also bound. In the present embodiment, the remotely controlled vehicle transmits a confirmation message back to the remote controller indicating that it is bound. In the present embodiment, the remotely controlled vehicle does not save the TX ID before this point (for example, at step 406) to allow the remote controller to determine (perhaps by prompting the user) which of several available transceivers to connect to.

In the unlikely event of a collision (where a different controller/vehicle ID pair may produce the same link ID, link tag, and CRC seed), the system should self-correct because the TX ID recovered by the remotely controlled vehicle will be different than that used by the remote controller that initiated the connection, leading to different channel selections in the hop algorithm. In this event, the devices should quickly lose connection, and the remotely controlled vehicle will resume listening for the correct connection establishment information.

The following is a more detailed description of how the various values that comprise the connection establishment information may be generated in accordance with one embodiment. In the following expressions, the identifier ‘C’ represents the remote controller ID and ‘R’ represents the remotely controlled vehicle ID. Subscripts are used to indicate which bits of an ID are used and the bit order. For example, C_{[31..24]} indicates the most significant byte of the controller ID, in natural bit order. The expression C_{[24..31]} refers to the same byte, but with reversed bit order. The operator ‘̂’ represents the bitwise exclusive-OR operation (modulo-1 bitwise addition). The specific expressions shown represent merely one embodiment, and the present invention is by no means limited to those formulas or expressions. Many other combinations may be used, although it is preferable (but not required) to maximize bit mixing (i.e., each bit of an ID should be combined with different bits in each expression) to reduce collisions.

In the present embodiment, the 8-bit link tag is the first byte of all radio packets transmitted by the remote controller and the remotely controlled vehicle. This may allow a receiving device to quickly discard messages intended for a different device. In the present embodiment, this value is calculated as (C_{[7..0]}̂C_{[15..8]}̂C_{[16..23]}̂C_{[24..31]}̂R_{[31..24]}̂R_{[23..16]}̂R_{[8..15]}̂R_{[0..7]}). During connection establishment, the remotely controlled vehicle accepts packets with any link tag, checks the link tag against the various ID hypotheses (e.g., checks the tag assuming it is from the remote controller having the TX ID received in the advertisement message), and, if the tags match, sends a reply using the received tag (which as discussed above will not, in the present embodiment, be the tag that will be used once the link is fully established).

In the present embodiment, the 16-bit CRC seed is used as the starting value for the 16-bit packet CRC. In this embodiment, a 16-bit CRC is included in every message for integrity checking. The CRC seed value is calculated as (C[31..16]̂C[0..15]̂R[15..0]̂R[16..31]). In the present embodiment, the remotely controlled device may treat this value the same way as the 8-bit link tag.

In the present embodiment, the mathematical function that is employed by the remote controller and remotely controlled vehicle to generate the link identifier is the exclusive-OR function applied to the full identifiers of the remote controller (TX ID) and the remotely controlled device (RX ID). That is, the link identifier is calculated as (R[31..0]̂C[31..0]). As mentioned above, this mathematical function has the following two properties: (1) given one of the identifiers input to the function (e.g., TX ID or RX ID), it is possible to reverse the function to retrieve the other identifier; and (2) if neither of the input identifiers is known, no information is provided about either of those identifiers. However, it is understood that this is just one example of a suitable mathematical function having those properties and other functions may be employed. For example, encryption functions such as the Digital Encryption Standard (DES), or other functions having the properties identified above may be used.

In the present embodiment, a hop sequence modifier is calculated as (R [31..0]̂C[0..31]). This value and the hop clock value are input to the hop sequence generation algorithm to generate the sequence of hop frequencies. Thus, as mentioned above, the hop sequence is controlled by three inputs, the hop clock value and the remote controller and remotely controlled vehicle identifiers (which are used to generate the hop sequence modifier). In the present embodiment, the hop clock value is a 32-bit value that is initialized to a random value by the remote controller. The current value is part of the connection establishment information transmitted to the remotely controlled vehicle. Both the remote controller and the remotely controlled vehicle increment the value (modulo 2³²) each packet transmission cycle to keep the hop sequence in synchronization. If two devices use the same hop clock value but different IDs (and hence different hop sequence modifiers), they will select different frequencies. Thus, the hop sequence modifier also helps to provide synchronization of the hop sequences of a remote controller and remotely controlled vehicle that are bound while ensuring that a different linked pair does not follow the same sequence.

Rendezvous and Non-Rendezvous Channels

As mentioned above, and as illustrated in step 414 of FIG. 4(b), the connection establishment information, which in the present embodiment includes the link tag, the link ID, the hop clock value, and the PN code to be used for direct sequence spread spectrum communications, is only transmitted on a subset of the channels of the hop sequence. This subset of channels is referred to herein as the “rendezvous channels.” In the present embodiment, in which there are seventy-nine (79) channels in the hop sequence, every fifth channel, starting with the third channel in the sequence, is used as a rendezvous channel. Thus, there are fifteen rendezvous channels. In other embodiments, however, there may be a different number of rendezvous channels. Preferably, the number of rendezvous channels is less than the total number of channels in the hop sequence. In the present embodiment, the confirmation message discussed above that the remotely controlled device transmits back to the remote controller in step 418 of FIG. 4(b) is also preferably transmitted on one or more of the rendezvous channels.

By only sending connection establishment information on a subset of channels (i.e., the rendezvous channels), the overall system power consumption may be reduced and link performance and reliability may be improved. Reduced power consumption may follow directly from less data being transmitted than if connection establishment information were transmitted on every channel. Link performance may be improved because the data bytes that would otherwise be used for connection establishment information may instead be available for additional payload. Reliability may be improved because smaller packets may be statistically less susceptible to random errors and may be better covered by the CRC.

In the present embodiment, the use of DSSS encoding requires that a common, well-known PN code is used by all radios on the rendezvous channels to permit the remotely controlled vehicle to successfully receive connection establishment information. This PN code is never selected for use on non-rendezvous channels by an active link.

As described below in connection with lost link recovery, and as illustrated in step 422 of FIG. 4, unlike the connection establishment information, information used to control the remotely controlled vehicle, such as servo position information or information used to control any other of the controllable mechanisms on the vehicle, is transmitted on substantially every channel of the hop sequence (including the rendezvous channels). Also, the remote controller continues to transmit such control information on substantially all of the channels of the hop sequence even if the remotely controlled vehicle happens to lose connection with or move out of range of the remote controller.

In one embodiment, an exception to sending control information on each of the channels of the hop sequence is that certain “non-real time” information (i.e., information that is not critical to the real-time operation of the remotely controlled vehicle) may not be transmitted on a rendezvous channel and may instead be held for transmission until the next non-rendezvous channel.

Lost Link Recovery

In the present embodiment, and in some applications including hobbyist racing applications and robotic explosives handling, the nature of the connection between the remote controller and remotely controlled vehicle may be relatively asymmetric. That is, the information transmitted from the remote controller to the remotely controlled device, such as for example, information to control the vehicle, may be relatively high priority and may require relatively low latency. On the contrary, information transmitted from the remotely controlled vehicle back to the remote controller, such as for example information reported by sensors on-board the vehicle, may be relatively low priority and a higher level of latency may be tolerated. Because of the asymmetric nature of such connections (high priority, low latency data from controller to vehicle and low priority, low rate return data), in the present embodiment, loss of link is treated differently by the controller and the vehicle.

In this embodiment, the remotely controlled vehicle maintains a count of consecutive missed packets. If this count exceeds a threshold value, the vehicle assumes a loss of the communication link has occurred, and the vehicle enters a link recovery mode. In this mode, the frequency hopping parameters are maintained, including regular updates of the hop clock, but the hop set is adapted to only include rendezvous channels and the radio frequency is changed at a reduced rate. That is, the remotely controlled vehicle begins listening on the rendezvous channels for connection establishment information from the remote controller. This improves the probability of resynchronizing with the controller (which may have restarted and changed connection parameters). By listening on each channel for several timeslots, the receiver can recover timing alignment with the controller. In one embodiment, this link recovery mode simply comprises the remotely controlled device re-performing steps 416 and 418 of the method illustrated in FIG. 4(b). Once the connection is reestablished, normal communications resume.

Further in accordance with this embodiment, the controller does not have an explicit link recovery mode. Rather, as illustrated in step 422 and described above, once a connection is established, the remote controller continues sending control information on substantially all of the channels of the hop sequence and connection establishment information on the rendezvous channels regardless of whether the remotely controlled device loses its connection. By continuing to transmit control information on substantially all of the channels of the hop sequence, the remote controller may optimize the chances that the remotely controlled vehicle will resume normal communications and receive that control information. For example, if the remote controller temporarily moves out of range of the remote controller but then moves back into range, it will quickly receive the latest control information that the remote controller has continued to send. And even if the remotely controlled vehicle needs to resynchronize its communications, it will still be able to receive the needed control information quickly. Thus, this mode of operation may be particularly advantageous in hobbyist racing applications or other adverse environments, where the remote controller may not be able to determine when the remote device has lost synchronization. This embodiment may allow a remotely controlled device to synchronize during normal operation without requiring a separate connection establishment phase.

Packet Formats

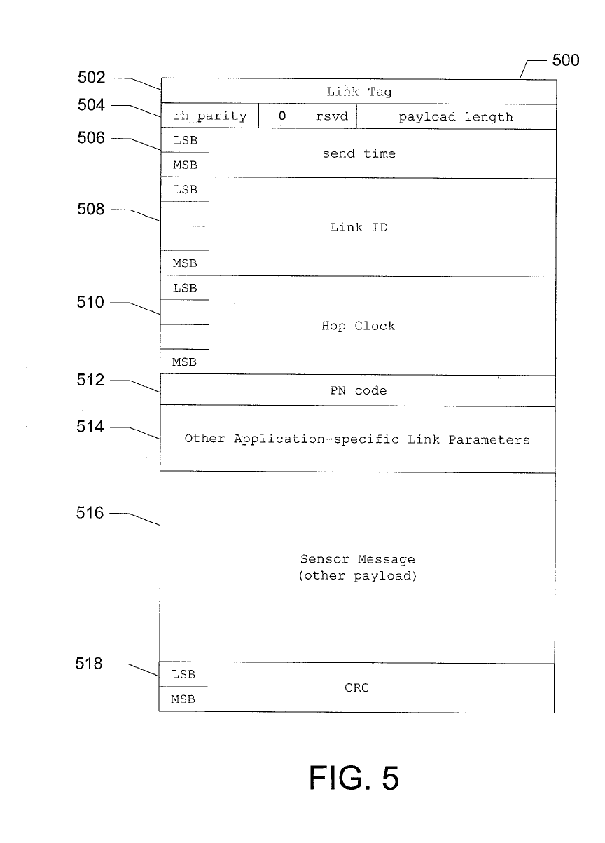

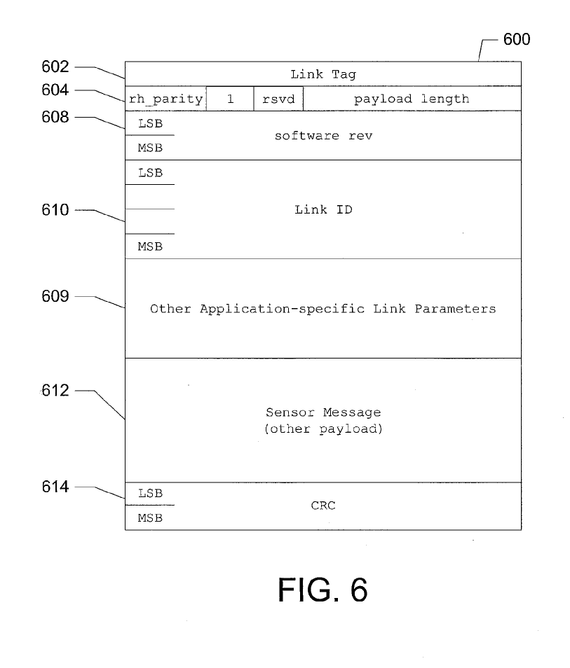

In the present embodiment, information is transmitted between the remote controller and remotely controlled vehicle in the form of packets of information. FIG. 5 illustrates one embodiment of a format of a packet of information transmitted from the remote controller to the remotely controlled vehicle, and FIG. 6 illustrates one embodiment of a format of a packet of information transmitted from the remotely controlled vehicle to the remote controller. In the present embodiment, packets are transmitted at a rate of one-hundred (100) packets per second. Thus, where the radios also hop at a rate of 100 times per second, one packet is transmitted on each channel of the hop sequence before hopping to the next channel in the sequence. In other embodiments, the packet transmission rate may be greater or lower. In the present embodiment, when the controller sends a message which requires a reply, the reply message is sent on the same channel as the original request. This prevents the situation where the request is sent on a clear channel and the reply is lost by changing to a noisy channel.

Referring to FIG. 5, the example packet format 500 for transmission from a remote controller to a remotely controlled device is shown. The 8-bit link tag mentioned above is provided at 502. A parity indicator and payload length indicator are provided at 504. At 506, a value (“send time”) is provided that represents the elapsed time between the time at which the controller hopped to the current frequency channel and the time it began transmitting the packet. This value may be used by the remotely controlled vehicle to aid in keeping its radio modem synchronized with the radio modem in the remote controller. In addition to the 8-bit link tag 502, other connection establishment information (which is provided only when transmitting on the rendezvous channels) comprises the hop clock value 510, the link identifier 508 and the PN code 512 to be used by the remote controller and remotely controlled vehicle when transmitting on non-rendezvous channels (“PN code”). Other application specific link parameters 514 may also be provided.

Information for controlling the remotely controlled vehicle or any other payload may be provided at 516. Typically, this information will be provided in some format known to the remotely controlled vehicle so that it can be readily extracted upon receipt and applied to the various control mechanisms (e.g. servos, motors, steering etc.) in the vehicle. At 518, the 16-bit CRC value is provided.

Referring to FIG. 6, the example packet format 600 for transmission from the remotely controlled vehicle to the remote controller is shown. In this example, the packet begins with the link tag 602. A parity indicator and payload length indicator are provided at 604. At 608, an indicator of the software revision employed in the remotely controlled vehicle may be provided. The link ID may be provided at 610. Other information associated with the remotely controlled vehicle, including other application-specific link identifiers, may be provided at 609. The fields 608, 609, and 610 may only be sent when establishing a connection. Information from any sensors on the vehicle, or any other payload, may be provided at 612. The packet format concludes with the 16-bit CRC value 614.

One-Way Operation

While the embodiment described above contemplates two-way communications between the remote controller and the remotely controlled vehicle, the system can also be used to provide just one-way operation—where the remotely controlled vehicle is only capable of receiving transmissions from the remote controller but is not capable of transmitting information back to the remote controller. When used in this manner, two modes of operation are possible. In the first, the bind process is completed though an external mechanism (either a cabled connection between the devices or an explicit programming step by the user). In a second mode of operation, a fixed receiver ID may be assigned to the remotely controlled vehicle. This remote ID will be used by all devices; only the remote controller identifier will identify the link. This reduces security but allows the user to rebind a receiver to a different transmitter at any time. In this mode, there are no reply messages from the vehicle, so the steps illustrated in FIG. 4(a) are skipped and both devices follow the steps illustrated in FIG. 4(b) from power-up, skipping any steps involving messages from the remotely controlled vehicle to the controller.

All or portions of the various systems, methods, and aspects of the present invention may be embodied in hardware, software, or a combination of both. When embodied in software, the methods and apparatus of the present invention, or certain aspects or portions thereof, may be embodied in the form of program code (i.e., instructions). This program code may be stored on a computer-readable medium, such as a magnetic, electrical, or optical storage medium, including without limitation a floppy diskette, CD-ROM, CD-RW, DVD-ROM, DVD-RAM, magnetic tape, flash memory, hard disk drive, or any other machine-readable storage medium, wherein, when the program code is loaded into and executed by a machine, such as a microprocessor, the machine becomes an apparatus for practicing the invention. The program code may be implemented in a high level procedural or object oriented programming language. Alternatively, the program code can be implemented in an assembly or machine language. In any case, the language may be a compiled or interpreted language.

The present invention may also be embodied in the form of program code that is transmitted over some transmission medium, such as over electrical wiring or cabling, through fiber optics, over a network, including a local area network, a wide area network, the Internet or an intranet, or via any other form of transmission, wherein, when the program code is received and loaded into and executed by a machine, such as a microprocessor, the machine becomes an apparatus for practicing the invention.

When implemented on a general-purpose processor, the program code may combine with the processor to provide a unique apparatus that operates analogously to specific logic circuits.

As the foregoing illustrates, the present invention is directed to systems and methods for communicating between a remote controller and a remotely controlled vehicle. It is understood that changes may be made to the embodiments described above without departing from the broad inventive concepts thereof. Accordingly, it is understood that the present invention is not limited to the particular embodiments disclosed, but is intended to cover all modifications that are within the spirit and scope of the invention as defined by the appended claims.

What is claimed:

1. A method for communicating between a remote controller and a remotely controlled vehicle, comprising at the remote controller:
establishing communications with the remotely controlled vehicle;
hopping through a plurality of different communication frequencies;
transmitting information for controlling the remotely controlled vehicle on substantially all of the plurality of communication frequencies;
transmitting information indicative of the established communications between the remote controller and the remotely controlled vehicle on a subset of said plurality of frequencies, the subset of frequencies comprising less than substantially all of the plurality of frequencies; and
continuing to transmit said information for controlling the remotely controlled vehicle on substantially all of the plurality of frequencies even if the remotely controlled vehicle loses communication with the remote controller.

2. The method recited in claim 1, wherein the remote controller and the remotely controlled vehicle each have a respective identifier and each identifier has a respective length, and wherein said step of establishing communications with the remotely controlled vehicle comprises:
transmitting a first message advertising that the remote controller is available to establish communications, the first message comprising the identifier of the remote controller;
receiving from the remotely controlled vehicle, in response to the first message, a second message and extracting therefrom the identifier of the remotely controlled vehicle;
applying a mathematical function to the identifiers of the remote controller and remotely controlled vehicle to generate an identifier representative of the established communications between them, the generated identifier having a length that is less than the combined lengths of the identifiers of the transceivers; and
periodically transmitting the generated identifier to the remotely controlled vehicle on said subset of frequencies as part of said information indicative of the established communications between the remote controller and the remotely controlled vehicle.

3. The method recited in claim 2, wherein a property of the mathematical function is that given the generated identifier and one of the identifiers of the remote controller and the remotely controlled vehicle, the other identifier can be determined.

4. The method recited in claim 2, wherein the remote controller and remotely controlled vehicle identifiers each have a same length L, and wherein the generated identifier has that same length L.

5. The method recited in claim 1, further comprising employing direct sequence spread spectrum communications when transmitting information on a given frequency of said plurality of frequencies.

6. A method for communicating between a remote controller and a remotely controlled vehicle, comprising at the remotely controlled vehicle:
establishing communications with the remote controller;
hopping through a plurality of different communication frequencies in synchronization with the remote controller;
receiving information for controlling the remotely controlled vehicle on substantially all of the plurality of communication frequencies;
receiving information indicative of the established communications between the remote controller and the remotely controlled vehicle on a subset of said plurality of frequencies, the subset of frequencies comprising less than substantially all of the plurality of frequencies; and
upon determining that the established communications with the remote controller have been interrupted, hopping through only said subset of frequencies to receive said information indicative of the established communications and reestablishing communications with the remote controller based thereon.

7. The method recited in claim 6, wherein the remote controller and the remotely controlled vehicle each have a respective identifier and each identifier has a respective length, and wherein said step of establishing communications with the remote controller comprises:
receiving a first message from the remote controller advertising that the remote controller is available to establish communications;
extracting from the first message the identifier of the remote controller;
applying a mathematical function to the extracted identifier of the remote controller and the identifier of the remotely controlled vehicle to generate an identifier representative of the established communications between them, the generated identifier having a length that is less than the combined lengths of the identifiers of the transceivers; and
transmitting to the remote controller, in response to the first message, a second message comprising the generated identifier.

8. The method recited in claim 7, wherein a property of the mathematical function is that given the generated identifier and one of the identifiers of the remote controller and the remotely controlled vehicle, the other identifier can be determined.

9. The method recited in claim 7, wherein the remote controller and remotely controlled vehicle identifiers each have a same length L, and wherein the generated identifier has that same length L.

10. The method recited in claim 6, further comprising employing direct sequence spread spectrum communications when receiving information on a given frequency of said plurality of frequencies.

11. A computer-readable storage medium having program code stored thereon for use in communicating between a remote controller and a remotely controlled vehicle, the program code, when executed by a processor of the remote controller, causing the remote controller to:
establish communications with the remotely controlled vehicle;
hop through a plurality of different communication frequencies;
transmit information for controlling the remotely controlled vehicle on substantially all of the plurality of communication frequencies;
transmit information indicative of the established communications between the remote controller and the remotely controlled vehicle on a subset of said plurality of frequencies, the subset of frequencies comprising less than substantially all of the plurality of frequencies; and
continue to transmit said information for controlling the remotely controlled vehicle on substantially all of the plurality of frequencies even if the remotely controlled vehicle loses communication with the remote controller.

12. The computer-readable storage medium recited in claim 11, wherein the remote controller and the remotely controlled vehicle each have a respective identifier and each identifier has a respective length, and wherein the program code further causes the remote controller to establish communications with the remotely controlled vehicle by:
transmitting a first message advertising that the remote controller is available to establish communications, the first message comprising the identifier of the remote controller;
receiving from the remotely controlled vehicle, in response to the first message, a second message and extracting therefrom the identifier of the remotely controlled vehicle;
applying a mathematical function to the identifiers of the remote controller and remotely controlled vehicle to generate an identifier representative of the established communications between them, the generated identifier having a length that is less than the combined lengths of the identifiers of the transceivers; and
periodically transmitting the generated identifier to the remotely controlled vehicle on said subset of frequencies as part of said information indicative of the established communications between the remote controller and the remotely controlled vehicle.

13. The computer-readable storage medium recited in claim 12, wherein a property of the mathematical function is that given the generated identifier and one of the identifiers of the remote controller and the remotely controlled vehicle, the other identifier can be determined.

14. The computer-readable storage medium recited in claim 12, wherein the remote controller and remotely controlled vehicle identifiers each have a same length L, and wherein the generated identifier has that same length L.

15. The computer-readable storage medium recited in claim 11, wherein the program code further causes the remote controller to employ direct sequence spread spectrum communications when transmitting information on a given frequency of said plurality of frequencies.

16. A computer-readable storage medium having program code stored thereon for use in communicating between a remote controller and a remotely controlled vehicle, the program code, when executed by a processor of the remotely controlled vehicle, causing the remotely controlled vehicle to:
establish communications with the remote controller;
hop through a plurality of different communication frequencies in synchronization with the remote controller;
receive information for controlling the remotely controlled vehicle on substantially all of the plurality of communication frequencies;
receive information indicative of the established communications between the remote controller and the remotely controlled vehicle on a subset of said plurality of frequencies, the subset of frequencies comprising less than substantially all of the plurality of frequencies; and
upon determining that the established communications with the remote controller have been interrupted, hop through only said subset of frequencies to receive said information indicative of the established communications and reestablish communications with the remote controller based thereon.

17. The computer-readable storage medium recited in claim 16, wherein the remote controller and the remotely controlled vehicle each have a respective identifier and each identifier has a respective length, and wherein the program code causes the remotely controlled vehicle to establish communications with the remote controller by:
receiving a first message from the remote controller advertising that the remote controller is available to establish communications;
extracting from the first message the identifier of the remote controller;
applying a mathematical function to the extracted identifier of the remote controller and the identifier of the remotely controlled vehicle to generate an identifier representative of the established communications between them, the generated identifier having a length that is less than the combined lengths of the identifiers of the transceivers; and
transmitting to the remote controller, in response to the first message, a second message comprising the generated identifier.

18. The computer-readable storage medium recited in claim 17, wherein a property of the mathematical function is that given the generated identifier and one of the identifiers of the remote controller and the remotely controlled vehicle, the other identifier can be determined.

19. The computer-readable storage medium recited in claim 17, wherein the remote controller and remotely controlled vehicle identifiers each have a same length L, and wherein the generated identifier has that same length L.

20. The computer-readable storage medium recited in claim 16, wherein the program code further causes the remotely controlled vehicle to employ direct sequence spread spectrum communications when receiving information on a given frequency of said plurality of frequencies.
